(19) United States
(12) Patent Application Publication
(10) Pub. No.: US 2014/0012657 A1
(43) Pub. Date: Jan. 9, 2014

(54) CLEARINGHOUSE FOR ELECTRONIC COUPONS

(71) Applicant: Paul Begum, Laguna Niguel, CA (US)

(72) Inventor: Paul Begum, Laguna Niguel, CA (US)

(21) Appl. No.: 13/926,997

(22) Filed: Jun. 25, 2013

Related U.S. Application Data
(60) Provisional application No. 61/668,382, filed on Jul. 5, 2012.

(51) Int. Cl. G06Q 30/02

(52) U.S. Cl. CPC G06Q 30/0239
USPC 705/14.39

(57) ABSTRACT

A clearinghouse for electronic coupons is provided to enable retailers to submit electronic coupons for redemption. A clearinghouse for electronic coupons can provide an application programming interface that retailers can use to interface their computer systems, such as a point of sale system, with the clearinghouse. The application programming interface allows retailers to submit electronic coupons for redemption automatically from the retailers' own computer systems thereby minimizing the overhead of accepting and redeeming electronic coupons. The clearinghouse can provide immediate notifications of the validity of a coupon or of the manufacturer's agreement to reimburse the value of the coupon.

### CROSS-REFERENCE TO RELATED APPLICATIONS

This application claims the benefit of U.S. Provisional Patent Application No. 61/668,382 which was filed on Jul. 5, 2012.

### BACKGROUND

Various clearinghouses for paper coupons exist. These clearinghouses function as an intermediary between the manufacturers that issue the paper coupons and the retail outlets that accept the paper coupons. When a customer redeems a coupon at a retail outlet, the retail outlet can send the coupon to the clearinghouse. The clearinghouse then interacts with the manufacturer that issued the coupon to receive reimbursement for the coupon. The reimbursement is then passed on to the retailer. For their services, clearinghouses generally retain a percentage of the reimbursements.

Although these clearinghouses work well with paper coupons, paper coupons are increasingly being replaced with electronic coupons. An electronic coupon is a coupon in a digital format. Electronic coupons can be distributed in various ways including by email, text, or mobile applications. Current clearinghouses for paper coupons have not provided an adequate solution for processing electronic coupons.

One difficulty that arises with electronic coupons when compared to paper coupons is that when a customer uses an electronic coupon at a retail outlet, the retail outlet does not receive a tangible item (i.e. paper) that can be sent to a clearinghouse. To address this issue, when many retailers accept an electronic coupon, they will print a copy of the coupon that can be sent to a clearinghouse for redemption. This step of printing a copy of each electronic coupon adds much difficulty to the coupon redemption process.

### BRIEF SUMMARY

The present invention extends to methods, systems, and computer program products for implementing a clearinghouse for electronic coupons. A clearinghouse for electronic coupons can provide an application programming interface that retailers can use to interface their computer systems, such as a point of sale system, with the clearinghouse. The application programming interface allows retailers to submit electronic coupons for redemption automatically from the retailers' own computer systems thereby minimizing the overhead of accepting and redeeming electronic coupons.

In one embodiment, a method for implementing a clearinghouse for electronic coupons comprises creating, at a clearinghouse system that implements a coupon bank, a first account. The first account defines a quantity of coupons for a first product that a manufacturer will reimburse. A first request is received from a first retailer system that requests to redeem a first electronic coupon in conjunction with the purchase of the first product. The first request is received at the clearinghouse system via an application programming interface. In response to the first request, the first account is accessed to determine the quantity defined in the first account. Upon determining that the quantity defined in the first account is not zero, a deduction is made from the quantity to reflect that the first electronic coupon has been redeemed. A notification that the first coupon has been redeemed is then sent to the first retailer system.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer environment in which a clearinghouse for electronic coupons can be implemented according to one or more embodiments of the invention;

FIG. 2 illustrates a clearinghouse system according to one or more embodiments of the invention;

FIG. 3 illustrates an exemplary coupon redemption request according to one or more embodiments of the invention; and

FIG. 4 illustrates a flowchart of an exemplary method for implementing a clearinghouse for electronic coupons according to one or more embodiments of the invention.

### DETAILED DESCRIPTION

The present invention extends to methods, systems, and computer program products for implementing a clearinghouse for electronic coupons. A clearinghouse for electronic coupons can provide an application programming interface that retailers can use to interface their computer systems, such as a point of sale system, with the clearinghouse. The application programming interface allows retailers to submit electronic coupons for redemption automatically from the retailers' own computer systems thereby minimizing the overhead of accepting and redeeming electronic coupons.

In one embodiment, a method for implementing a clearinghouse for electronic coupons comprises creating, at a clearinghouse system that implements a coupon bank, a first account. The first account defines a quantity of coupons for a first product that a manufacturer will reimburse. A first request is received from a first retailer system that requests to redeem a first electronic coupon in conjunction with the purchase of the first product. The first request is received at the clearinghouse system via an application programming interface. In response to the first request, the first account is accessed to determine the quantity defined in the first account. Upon determining that the quantity defined in the first account is not zero, a deduction is made from the quantity to reflect that the first electronic coupon has been redeemed. A notification that the first coupon has been redeemed is then sent to the first retailer system.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

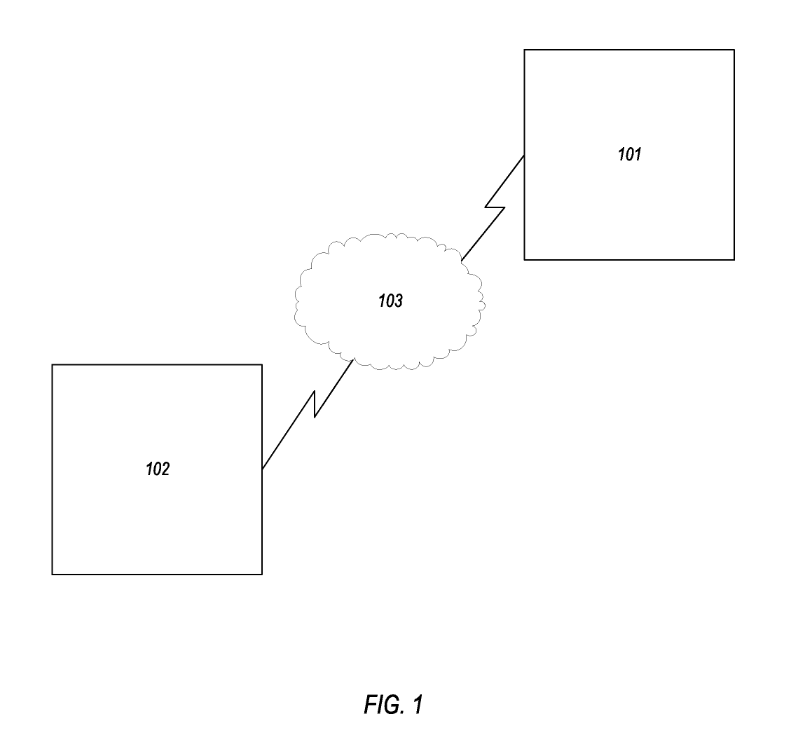

FIG. 1 illustrates an exemplary computer environment 100 in which a clearinghouse for electronic coupons can be implemented according to one or more embodiments of the invention. Computer environment 100 includes clearinghouse system 101 and retailer system 102. Retailer system 102 is connected to clearinghouse system 101 via network 103. Network 103 represents any of the various types of network architectures known in the art.

In a typical example, network 103 includes the internet and a local area network used by retailer system 102 to connect to the internet. Retailer system 102 can communicate with clearinghouse system 101 over network 103 using any number and combination of various protocols as known in the art. Accordingly, the specific manner in which retailer system 102 communicates over network 103 is not essential to the invention.

Clearinghouse system 101 comprises one or more computer systems. In a particular example, clearinghouse system 101 can comprise a cloud of servers although any configuration of computer systems could be used to implement clearinghouse system 101.

Retailer system 102 also comprises one or more computer systems. In a particular example, retailer system 102 can comprise one or more servers that are integrated with one or more point of sale systems. For example, a retail outlet could have a single server located at the retail outlet that is connected to a plurality of point of sale terminals.

Alternatively, one or more servers could be located outside of a particular retail outlet such as when one or more common servers serve a plurality of retail outlets. Additionally, each individual point of sale terminal could also be configured to directly communicate with clearinghouse system 101.

Accordingly, the particular architecture implemented by any particular retailer is not essential to the invention because clearinghouse system 101 provides an application programming interface that can be used by any computer system to communicate with clearinghouse system 101. In the remainder of the description, retailer system 102 will be referred to generally as describing any portion of the computer architecture implemented by a particular retailer to communicate with clearinghouse system 101.

When a customer visits a retail outlet and desires to use an electronic coupon, retailer system 102 can be used to accept the electronic coupon. An electronic coupon can be accepted in various ways such as by scanning a barcode displayed on the customer's mobile phone, or by otherwise entering an identifier of the coupon into retailer system 102.

Similarly, a customer's portable electronic device can be configured to automatically transfer coupons to retailer system 102. For example, a mobile application can be used to manage a customer's electronic coupons. The mobile application can be configured to interface with retailer system 102 to transfer applicable coupons to retailer system 102 for use when the customer checks out at the retail outlet.

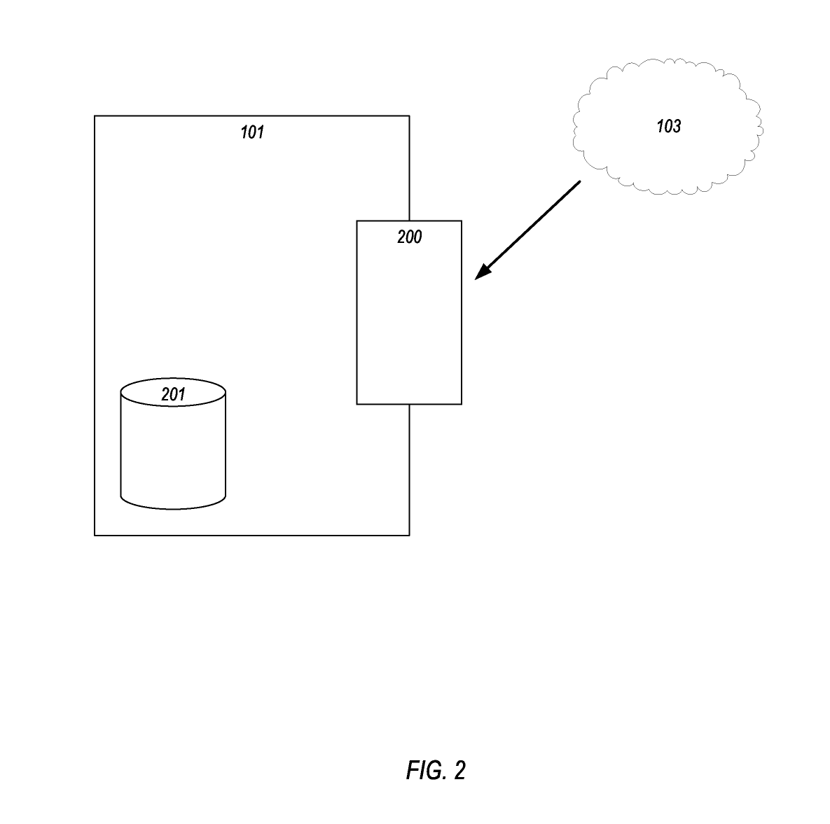

Regardless of the manner in which a customer's coupons are transferred to retailer system 102, retailer system 102 communicates with clearinghouse system 101 to redeem the coupons. As shown in FIG. 2, retailer system 102 can perform these communications automatically using application programming interface 200. Application programming interface 200 comprises an interface for submitting, over network 103, identifiers of coupons to clearinghouse system 101 for redemption.

FIG. 2 also illustrates that clearinghouse system 101 includes a coupon bank 201. Coupon bank 201 comprises a database that stores accounts for manufacturers that offer coupons on their products. For example, if a manufacturer desires to offer coupons for one of the manufacturer's products, the manufacturer can create an account in coupon bank 201. Once the account is created, any number of retailer systems 102 can use application programming interface 200 to redeem coupons that are used to purchase the product against the account.

An account in coupon bank 201 specifies a quantity of coupons that the manufacturer will reimburse. For example, a manufacturer can specify that it will reimburse up to 100 coupons for product X. Alternatively, the manufacturer can specify that it will reimburse up to some dollar amount for coupons for product X. Accordingly, coupon bank 201 can maintain an account for coupons for product X having an initial balance of 100 (or the dollar equivalent if so specified).

As coupons are redeemed by retailer systems 102, coupon bank 201 deducts from the specified quantity in the account established for the coupons. For example, if retailer systems 102 submit five redemption requests for coupons for product X, coupon bank 201 can update the account for coupons for product X to have a balance of 95. In this way, an accurate, real-time balance is maintained for each coupon account.

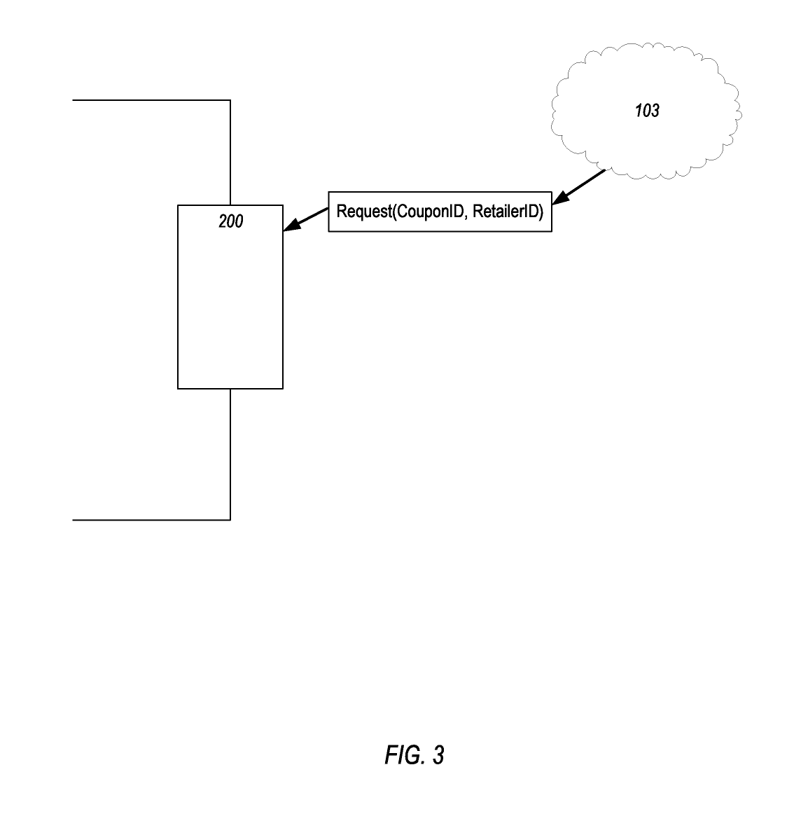

FIG. 3 illustrates an example of a coupon redemption request 300 submitted by retailer system 102 using application programming interface 200. As shown, request 300 includes an identifier of a coupon 301, and an identifier of the retailer system 302. In some embodiments, each individual coupon can have a unique identifier, or all coupons for the same product can share an identifier. In any case, coupon bank 201 is configured to understand the identifier of any coupon for which an account has been established. Identifier 301 is used to identify the appropriate account in coupon bank 200 to be used to reimburse the retailer for accepting the coupon. Identifier 302 is used to identify the particular retailer system 102 to which the reimbursement is to be credited.

In some embodiments, request 300 can include additional information regarding the coupon, product, retailer, etc. For example, if a coupon is applicable to a range of products, request 300 can specify which product was purchased with the coupon. Also, request 300 can specify the customer who used the coupon (e.g. a unique identifier of a customer's account or mobile device on which the coupon was displayed). Similarly, request 300 can identify the format of the coupon that was used (e.g. whether the coupon was in an email). Such information can be made available to the manufacturer to assist the manufacturer in determining the effectiveness of its coupons.

Clearinghouse system 101 can be used to provide immediate clearing of a coupon. For example, when a coupon is entered into retailer system 102, retailer system 102 can immediately send a request to clearinghouse system 101 via application programming interface 200. The request can be processed by coupon bank 201 to determine whether the coupon should be honored. For example, if a unique identifier is used on each coupon, coupon bank 201 can determine if the coupon has already been used (i.e. whether the current coupon is a copy) by comparing the identifier to the identifiers of previously used coupons. Coupon bank 201 can then determine whether to honor the coupon based on various criteria, such as manufacturer rules regarding copies of coupons, and notify retailer system 102 accordingly.

Similarly, coupon bank 201 can access the appropriate account to determine whether a balance remains for the coupon. For example, referring to the same example above, if 100 coupons had already been redeemed for product X (as evidenced by the balance of the account being zero), coupon bank 201 can notify retailer system 102 that the account for the coupon has already been exhausted. A manufacturer can specify rules that apply when an account balance has been exhausted. For example, a manufacturer may agree to reimburse the full amount of the coupon, a reduced percentage of the amount, or no amount. Coupon bank 201 can notify retailer system 102 of these rules to allow retailer system 102 to determine whether to honor the coupon. These notifications can be sent by clearinghouse system 101 to retailer system 102 immediately to allow retailer system 102 to make a decision regarding the coupon while the customer is checking out.

In some embodiments, clearinghouse system 101 can implement or interface with customer accounts. For example, a customer account can be used to store electronic coupons for a customer. When a customer uses an electronic coupon in his account, an identifier of the electronic coupon and/or of the customer can be included in the request sent to clearinghouse system 101. Clearinghouse system 101 can use this identifier to access the customer's account and remove the electronic coupon from the customer's account.

The clearinghouse system of the present invention provides a general interface (application programming interface 200) by which any retailer system can communicate with clearinghouse system to redeem coupons. Accordingly, the present invention facilitates the process of accepting and redeeming electronic coupons. The clearinghouse system also increases the security of coupon redemption by providing real-time information regarding the validity of coupons and the manufacturer's agreement to reimburse coupons.

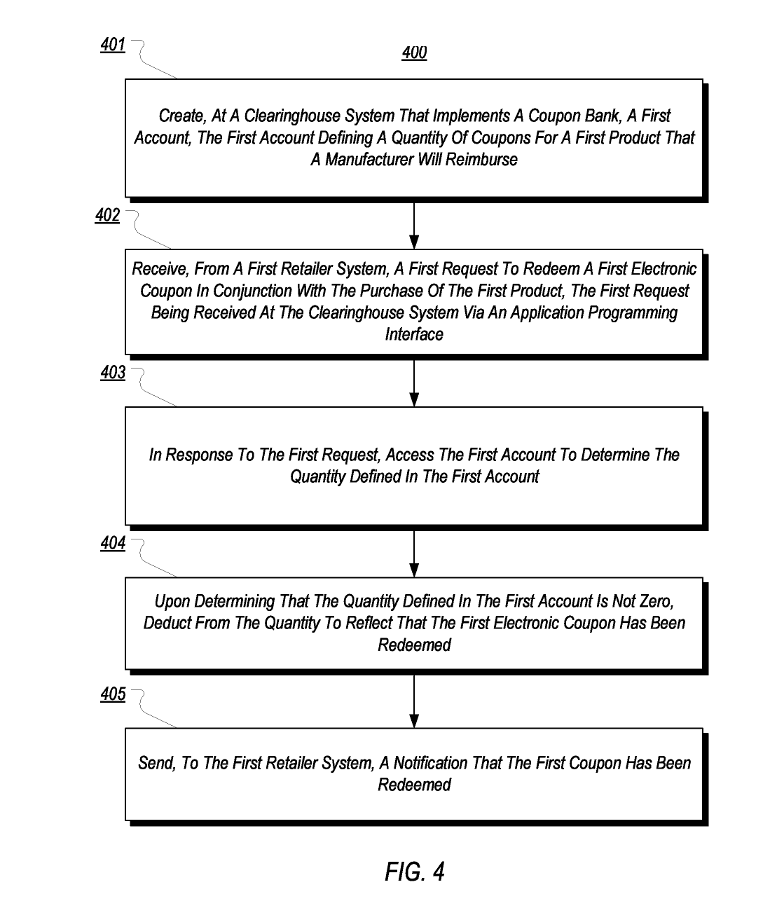

FIG. 4 illustrates a flowchart of an exemplary method 400 for implementing a clearinghouse for electronic coupons. Method 400 will be described with reference to FIGS. 1-3.

Method 400 includes an act 401 of creating, at a clearinghouse system that implements a coupon bank, a first account, the first account defining a quantity of coupons for a first product that a manufacturer will reimburse. For example, a first account can be created in coupon bank 201 of clearinghouse system 101.

Method 400 includes an act 402 of receiving, from a first retailer system, a first request to redeem a first electronic coupon in conjunction with the purchase of the first product, the first request being received at the clearinghouse system via an application programming interface. For example, a first request can be received from retail system 102 via application programming interface 200.

Method 400 includes an act 403 of, in response to the first request, accessing the first account to determine the quantity defined in the first account. For example, the first account in coupon bank 201 can be accessed to determine a quantity defined in the first account.

Method 400 includes an act 404 of, upon determining that the quantity defined in the first account is not zero, deducting from the quantity to reflect that the first electronic coupon has been redeemed. For example, coupon bank 201 can deduct from the quantity defined in the first account to indicate that the first electronic coupon has been redeemed.

Method 400 includes an act 405 of sending, to the first retailer system, a notification that the first coupon has been redeemed. For example, clearinghouse system 101 can send a notification to retail system 102 that the coupon has been redeemed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer program product comprising one or more computer storage media storing computer executable instructions which when executed perform a method for implementing a clearinghouse for electronic coupons, the method comprising:
creating, at a clearinghouse system that implements a coupon bank, a first account, the first account defining a quantity of coupons for a first product that a manufacturer will reimburse;
receiving, from a first retailer system, a first request to redeem a first electronic coupon in conjunction with the purchase of the first product, the first request being received at the clearinghouse system via an application programming interface;
in response to the first request, accessing the first account to determine the quantity defined in the first account;
upon determining that the quantity defined in the first account is not zero, deducting from the quantity to reflect that the first electronic coupon has been redeemed; and
sending, to the first retailer system, a notification that the first coupon has been redeemed.

2. The computer program product of claim 1, further comprising:
receiving, from a second retailer system, a second request to redeem a second electronic coupon in conjunction with the purchase of the first product, the second request being received at the clearinghouse system via the application programming interface;
in response to the second request, accessing the first account to determine the quantity defined in the first account;
upon determining that the quantity defined in the first account is not zero, deducting from the quantity to reflect that the second electronic coupon has been redeemed; and
sending, to the second retailer system, a notification that the second coupon has been redeemed.

3. The computer program product of claim 2, wherein the first request includes an identifier of the first coupon, and the second request includes an identifier of the second coupon.

4. The computer program product of claim 3, wherein the identifier of the first and second coupon is the same.

5. The computer program product of claim 3, wherein accessing the first account further comprises using the identifier of the first and second coupon to identify the first account.

6. The computer program product of claim 3, further comprising:
using the identifier of the first and second coupon to validate the first and second coupon.

7. The computer program product of claim 3, further comprising:
accessing the identifier of the first coupon;
verifying the validity of the first coupon using the identifier of the first coupon; and
upon determining that the identifier of the first coupon is not valid, sending a notification to the first retailer system that the first coupon is not valid.

8. The computer program product of claim 2, wherein the first request includes an identifier of the first retailer system, and the second request includes an identifier of the second retailer system.

9. The computer program product of claim 2, further comprising:
receiving, from a third retailer system, a third request to redeem a third electronic coupon in conjunction with the purchase of the first product, the third request being received at the clearinghouse system via the application programming interface;
in response to the third request, accessing the first account to determine the quantity defined in the first account;
upon determining that the quantity defined in the first account is zero, sending, to the third retailer system, a notification that the first account is zero.

10. The computer program product of claim 9, wherein the notification that the first account is zero includes rules regarding how the manufacturer will reimburse for the use of coupons for the first product when the first account is zero.

11. The computer program product of claim 10, wherein the rules define that the manufacturer will reimburse a reduced amount or no amount of the value of the coupon.

12. The computer program product of claim 1, wherein the first request includes an identifier of a customer that is using the first coupon.

13. The computer program product of claim 12, further comprising:
accessing an account associated with the customer that is using the first coupon; and
removing the first coupon from the account associated with the customer.

14. A computer system for implementing a clearinghouse for electronic coupons, the computer system comprising:
one or more processors; and
one or more computer storage media storing computer executable instructions which when executed perform a method for implementing a clearinghouse for electronic coupons, the method comprising:
creating, at a clearinghouse system that implements a coupon bank, a first account, the account defining a quantity of coupons for a first product that a manufacturer will reimburse;
receiving, from a first retailer system, a first request to redeem a first electronic coupon in conjunction with the purchase of the first product, the first request being received at the clearinghouse system via an application programming interface;
in response to the first request, accessing the first account to determine the quantity defined in the first account;
upon determining that the quantity defined in the first account is not zero, deducting from the quantity to reflect that the first electronic coupon has been redeemed; and
sending, to the first retailer system, a notification that the first coupon has been redeemed.

15. The computer system of claim 14, wherein the method implemented by executing the computer executable instructions further comprises:
receiving, from a second retailer system, a second request to redeem a second electronic coupon in conjunction with the purchase of the first product, the second request being received at the clearinghouse system via the application programming interface;
in response to the second request, accessing the first account to determine the quantity defined in the first account;
upon determining that the quantity defined in the first account is not zero, deducting from the quantity to reflect that the second electronic coupon has been redeemed; and
sending, to the second retailer system, a notification that the second coupon has been redeemed.

16. The computer system of claim 14, wherein the first request includes an identifier of the first coupon.

17. The computer system of claim 16, wherein accessing the first account further comprises using the identifier of the first coupon to identify the first account.

18. The computer system of claim 14, wherein the first request includes an identifier of a customer that is using the first coupon.

19. The computer system of claim 18, wherein the method implemented by executing the computer executable instructions further comprises:
accessing an account associated with the customer that is using the first coupon; and
removing the first coupon from the account associated with the customer.

20. The computer system of claim 14, wherein the method implemented by executing the computer executable instructions further comprises:
receiving, from a second retailer system, a second request to redeem a second electronic coupon in conjunction with the purchase of the first product, the second request being received at the clearinghouse system via the application programming interface;
in response to the second request, accessing the first account to determine the quantity defined in the first account;
upon determining that the quantity defined in the first account is zero, sending, to the second retailer system, a notification that the first account is zero.
